(19) United States
(12) Patent Application Publication
(10) Pub. No.: US 2026/0149371 A1
(43) Pub. Date: May 28, 2026

(54) POWER SUPPLY DEVICE WITH DC-DC CONVERTER AND RIPPLE SWITCH

(71) Applicant: SAMSUNG ELECTRONICS CO., LTD., Suwon-si (KR)

(72) Inventors: Hongseok SHIN, Suwon-si (KR); Dongyeon Kwag, Suwon-si (KR); Hyeungjoon Cha, Suwon-si (KR); Daehoon Han, Suwon-si (KR)

(73) Assignee: SAMSUNG ELECTRONICS CO., LTD., Suwon-si (KR)

(21) Appl. No.: 19/223,973

(22) Filed: May 30, 2025

(30) Foreign Application Priority Data
Nov. 25, 2024 (KR) 10-2024-0169799
Jan. 13, 2025 (KR) 10-2025-0004854

(51) Int. Cl. H02M 3/155

(52) U.S. Cl. CPC H02M 3/155

(57) ABSTRACT

A power supply device includes a DC-DC converter and a ripple generator. The DC-DC converter includes: a first switch connected between an input node and a first switching node, and a second switch connected between a reference node supplying a reference voltage and the first switching node. The DC-DC converter is configured to output an output voltage adjusting the input voltage by switching operation of each of the first switch and the second switch, to an output node. The ripple generator includes a first capacitor connected to the output node, a first resistive circuit connected between the first capacitor and a second switching node, a first ripple switch connected between the second switching node and the input node, a second ripple switch connected between the second switching node and the reference node, and a third ripple switch connected between the second switching node and the output node.

### CROSS-REFERENCE TO RELATED APPLICATION(S)

This application claims benefit of priority to Korean Patent Application No. 10-2024-0169799 filed on November 25, 2024 and Korean Patent Application No. 10-2025-0004854 filed on January 13, 2025 in the Korean Intellectual Property Office, the disclosures of which are incorporated herein by reference in its entirety.

### BACKGROUND

The present disclosure relates to a power supply device.

Many systems include a voltage supply device generating a power voltage required for operation by using an external power voltage supplied from an external source. For example, the voltage supply device may use the external power voltage as an input voltage to generate an output voltage on a level, higher or lower than that of the input voltage. In order to respond to various applications, various additional circuits for stably maintaining the output voltage generated by a power supply device may be included in the power supply device.

### SUMMARY

An aspect of the present disclosure is to provide a power supply device implementing a ripple generator connected to a DC-DC converter of the power supply device with ripple switches implemented as separate elements from switches included in the DC-DC converter, and connecting the ripple generator to the output node of the DC-DC converter during a period of time during which all the switches included in the DC-DC converter are turned off, to effectively prevent a malfunction thereof.

According to an aspect of the disclosure, a power supply device includes: a DC-DC converter; and a ripple generator, in which the DC-DC converter includes: a first switch connected between an input node supplying an input voltage and a first switching node, and a second switch connected between a reference node supplying a reference voltage, different from the input voltage, and the first switching node, in which the DC-DC converter is configured to output an output voltage, which is different from the input voltage, by switching operation of each of the first switch and the second switch, to an output node, and in which the ripple generator includes: a first capacitor connected to the output node, a first resistive circuit connected between the first capacitor and a second switching node, a first ripple switch connected between the second switching node and the input node, a second ripple switch connected between the second switching node and the reference node, and a third ripple switch connected between the second switching node and the output node.

According to an aspect of the disclosure, a power supply device includes: a DC-DC converter configured to receive an input voltage and output an output voltage, the DC-DC converter comprising a first switch and a second switch; a ripple generator connected to an output node of the DC-DC converter, the ripple generator comprising a first ripple switch, a second ripple switch, and a third ripple switch; and a controller configured to control the first switch, the first ripple switch, the second switch, the second ripple switch, and the third ripple switch, in which the ripple generator comprises a first resistive circuit connected to a switching node to which the first ripple switch, in which the second ripple switch and the third ripple switch are connected to each other, and a first capacitor connected between the first resistive circuit and the output node, in which the third ripple switch is connected between the switching node and the output node, and in which the controller turns the third ripple switch on during at least a portion of a dead period of time during which the first switch, the first ripple switch, the second switch, and the second ripple switch are turned off.

According to an aspect of the disclosure, a power supply device includes: a DC-DC converter; and a ripple generator, in which the DC-DC converter includes: at least one inductor, a first switch, and a second switch, in which the at least one inductor, the first switch, and the second switch are connected to each other at a first switching node, and in which the ripple generator includes at least one ripple switch connected between an output node of the DC-DC converter and a second switching node, a first resistive circuit, and a first capacitor, connected in series, between the output node and the second switching node.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a block diagram illustrating a power supply device according to one or more embodiments.

FIG. 2 is a view illustrating a power supply device according to one or more embodiments.

FIG. 3 is a view illustrating an electronic device including a ripple generator included in a power supply device according to one or more embodiments.

FIGS. 4 and 5 are views illustrating an electronic device including a ripple generator included in a power supply device according to one or more embodiments.

FIG. 6 is a circuit diagram illustrating a power supply device according to one or more embodiments.

FIGS. 7 to 12 are views illustrating an operation of a power supply device according to one or more embodiments.

FIG. 13 is a waveform diagram illustrating an operation of a power supply device according to one or more embodiments.

FIG. 14 is a view illustrating a system including a power supply device according to one or more embodiments.

### DETAILED DESCRIPTION

Hereinafter, preferred embodiments will be described with reference to the attached drawings.

It will be understood that, although the terms first, second, third, fourth, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

A layer may be described as having an upper surface and a lower surface. As understood by one of ordinary skill in the art, the surfaces of a layer may also be described as first and second surfaces, where a first surface may be one of the upper surface and the lower surface of the layer, and the second surface may be the other of the upper surface and the lower surface of the layer.

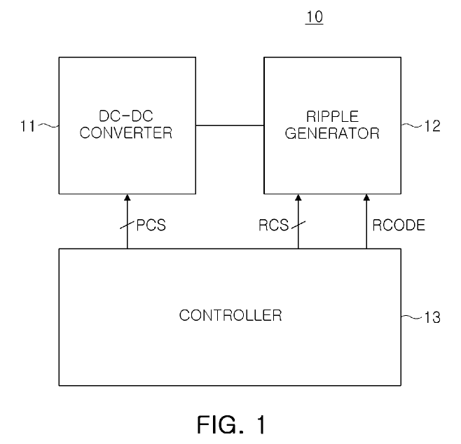

FIG. 1 is a block diagram illustrating a power supply device according to one or more embodiments.

Referring to FIG. 1, a power supply device 10 according to one or more embodiments may include a DC-DC converter 11, a ripple generator 12, a controller 13, and the like. The DC-DC converter 11 may be implemented as a circuit such as a buck converter, a boost converter, a buck-boost converter, or the like, and may include at least one switch. The DC-DC converter 11 may increase or decrease a level of an input voltage, which may be a direct current voltage, to output an output voltage. In one or more examples, the DC-DC converter may be an electronic circuit or electromechanical device that converts a source of DC from one voltage level to another. The DC-DC converter may be referred to as an electric power converter or a DC-to-DC converter.

The ripple generator 12 may be electrically connected to the DC-DC converter 11, and may assist an operation of the DC-DC converter 11. For example, the DC-DC converter 11 may include at least one inductor, and an oscillation phenomenon may occur due to a phase difference between the output voltage of the DC-DC converter 11 and an inductor current.

In one or more embodiments, the ripple generator 12 may be connected to the DC-DC converter 11, an oscillation phenomenon due to a phase difference between an output voltage and an inductor current may be minimized. For example, the ripple generator 12 may include at least one resistive circuit, at least one capacitor, a ripple switch, and the like, and may be connected to an output node of the DC-DC converter 11. In one or more examples, the ripple generator 12 may be used to simulate and introduce controlled voltage or current fluctuations (ripples) onto a DC power line to test a sensitivity of electronic components. For example, the ripple generator 12 may simulate unwanted voltage or current fluctuations (ripples) that can occur on a DC power line. These ripples can arise from various sources such as the switching of power electronics in inverters or chargers.

The resistive circuit included in the ripple generator 12 may include a plurality of unit circuits to be connected in series with each other, and each of the plurality of unit circuits may include a unit resistor and a transmission gate connected in parallel with the unit resistor. A resistance value of the resistive circuit may be determined by a resistance code RCODE controlling on or off states of the transmission gate included in each of the plurality of unit circuits, and the resistance code RCODE may be determined by the controller 13, for example.

In a structure in which the switch included in the DC-DC converter 11 and the ripple switch included in the ripple generator 12 are not implemented as separate elements separated from each other, the resistive circuit of the ripple generator 12 may be directly connected to the switch of the DC-DC converter 11. In this case, during a period of time during which the switch of the DC-DC converter 11 is turned off, a negative voltage may be applied to the resistive circuit due to a diode component present in the switch of the DC-DC converter 11. When the negative voltage is applied to the resistive circuit, at least one transmission switch included in the plurality of unit circuits included in the resistive circuit may be turned on regardless of the resistance code RCODE, and the resistance value of the resistive circuit may not be set as an intended target resistance value.

In one or more embodiments, the switch included in the DC-DC converter 11 and the ripple switch included in the ripple generator 12 may be implemented as separate elements to be separated from each other, and may be controlled by the controller 13, respectively. For example, the controller 13 may output a power control signal PCS that turns the switch of the DC-DC converter 11 on or off, and a ripple control signal RCS that turns the ripple switch of the ripple generator 12 on or off. Therefore, even during a period of time during which the switch of the DC-DC converter 11 is turned off by the power control signal PCS, the ripple switch may be appropriately controlled with the ripple control signal RCS, to prevent a negative voltage from being applied to the resistive circuit of the ripple generator 12, and maintain the resistance value of the resistive circuit as a target resistance value according to the resistance code RCODE.

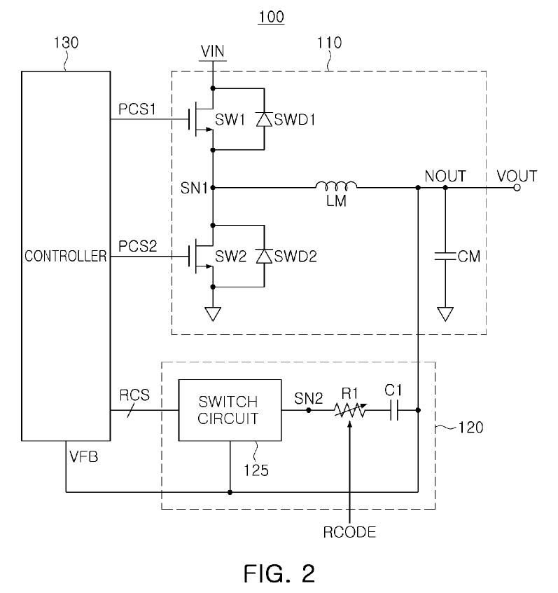

FIG. 2 is a view illustrating a power supply device according to one or more embodiments.

Referring to FIG. 2, a power supply device 100 according to one or more embodiments may include a DC-DC converter 110, a ripple generator 120, a controller 130, and the like. The DC-DC converter 110 may include a first switch SW1, a second switch SW2, an inductor LM, a capacitor CM, and the like. Depending on one or more embodiments, elements included in the DC-DC converter 110 may be changed. For example, the DC-DC converter 110 may include only one switch, or may include a resistor connected in series with the inductor LM.

The first switch SW1 may be connected between a first switching node SN1 and an input node supplying an input voltage VIN, and the second switch SW2 may be connected between a reference node supplying a reference voltage, different from the input voltage VIN, and the first switching node SN1. In one or more embodiments, the reference voltage may be a ground voltage, less than the input voltage VIN. The first switch SW1 may be controlled by a first power control signal PCS1 output by the controller 130, and the second switch SW2 may be controlled by a second power control signal PCS2 output by the controller 130.

The inductor LM may be connected to the first switching node SN1, and the capacitor CM may be connected between an output node NOUT and the reference node. The inductor LM and the capacitor CM may be connected to each other, with the output node NOUT therebetween.

When the first switch SW1 is turned on, an inductor current flowing in the inductor LM by the input voltage VIN may increase, and an output voltage VOUT may increase. When the second switch SW2 is turned on, the first switching node SN1 may be connected to the reference node, such that the inductor current may decrease, and the output voltage VOUT may decrease. The controller 130 may receive a feedback voltage VFB from the output node NOUT, and may control on or off states of each of the first switch SW1 and the second switch SW2 with reference to the feedback voltage VFB, thereby adjusting the output voltage VOUT. For example, the controller 130 may increase a turn-on period of time of the first switch SW1 during which the feedback voltage VFB decreases, and may increase a turn-on period of time of the second switch SW2 during which the feedback voltage VFB increases, thereby adjusting the output voltage VOUT. In one or more examples, the turn-on periods for the first switch SW1 and the second SW2 are variable. For example, during a first period of operation, the turn-on period for the first switch SW1 may be the same as the turn-on period for the second switch SW2. During a second period of operation, the turn-on period for the first switch SW1 may be longer than the turn-on period for the second switch SW2. During a third period of operation, the turn-on period for the first switch SW1 may be less than the turn-on period for the second switch SW2.

The ripple generator 120 may include a first resistive circuit R1, a first capacitor C1, a switch circuit 125, and the like. As described above, the first resistive circuit R1 may include a plurality of unit circuits, and may have a resistance value determined by a resistance code RCODE input from an external source. In one or more embodiments, the resistance code RCODE may be generated by the controller 130. According to one or more embodiments, the ripple generator 120 may further include a resistor and a capacitor, in addition to the first resistive circuit R1 and the first capacitor C1.

The first resistive circuit R1 may be connected between the switch circuit 125 and the first capacitor C1, and the first capacitor C1 may be connected to the output node NOUT. A node between the switch circuit 125 and the first resistive circuit R1 may be defined as a second switching node SN2. The switch circuit 125 may include a plurality of ripple switches operating in response to a ripple control signal RCS output by the controller 130.

For example, the switch circuit 125 may include a first ripple switch connected between the input node and the second switching node SN2, a second ripple switch connected between the reference node and the second switching node SN2, and the like. The first ripple switch may be turned on, together with the first switch SW1, and the second ripple switch may be turned on, together with the second switch SW2. To prevent the first resistive circuit R1 from being directly connected to the first switching node SN1, the first ripple switch and the second ripple switch, included in the switching circuit 125, may be implemented as separate elements from the first switch SW1 and the second switch SW2.

According to one or more embodiments, the switch circuit 125 may include a third ripple switch connected between the output node NOUT and the second switching node SN2. In one or more embodiments, the third ripple switch may be turned on during a period of time during which both the first ripple switch and the second ripple switch are turned off. The third ripple switch may be turned on during a period of time during which both the first ripple switch and the second ripple switch are turned off, to supply the output voltage VOUT to the second switching node SN2, and to prevent a negative voltage from being supplied to the first resistive circuit R1. Therefore, the unit circuits included in the first resistive circuit R1 may be prevented from performing an operation, different from the resistance code RCODE, and a malfunction of the power supply device 100 may be effectively prevented.

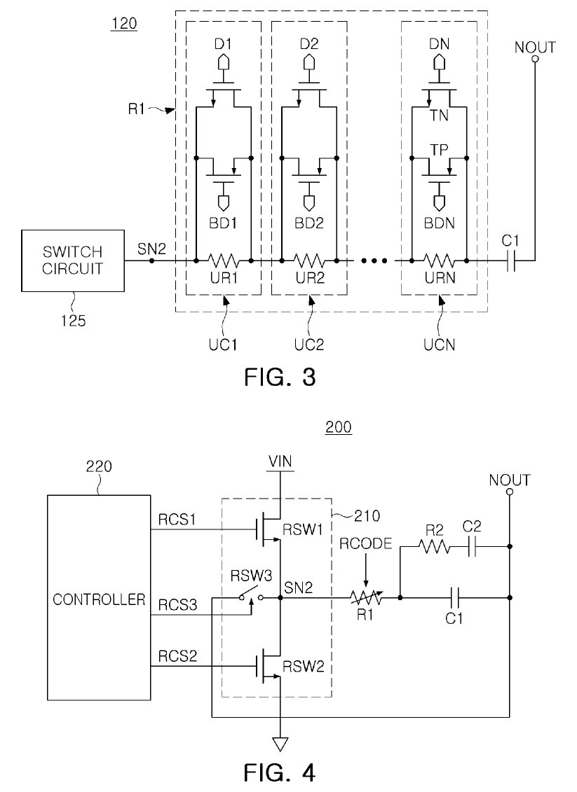

FIG. 3 is a view illustrating an electronic device including a ripple generator included in a power supply device according to one or more embodiments.

FIG. 3 is a view illustrating a ripple generator 120 included in a power supply device 100 according to one or more embodiments illustrated in FIG. 2. Referring to FIG. 3, a second switching node SN2 may be defined between a first resistive circuit R1 and a switch circuit 125, and a first capacitor C1 may be connected between the first resistive circuit R1 and an output node NOUT.

The first resistive circuit R1 may include a plurality of unit circuits UC1 to UCN connected in series between the second switching node SN2 and the first capacitor C1. Each of the plurality of unit circuits UC1 to UCN may include unit resistors UR1 to URN and transmission gates connected in parallel with the unit resistors UR1 to URN. The transmission gates may include an NMOS transmission switch TN and a PMOS transmission switch TP, connected in parallel with each other.

A resistance value of the first resistive circuit R1 may be determined by a resistance code input from the outside, and for example, the resistance code may include data of N bits (e.g., N is a natural number equal to or greater than 2). For example, the resistance code may be a binary code represented by a string of 1’s and 0’s. For example, if N is equal to 3, the resistance code may be represented by one of the following binary codes: 000, 001, 010, 011, 100, 101, 110, 111. In one or more embodiments illustrated in FIG. 3, an operation of each of the N unit circuits UC1 to UCN may be controlled by the N bits of data. Referring to FIG. 3, on or off states of a transmission gate included in a first unit circuit UC1 may be determined by a first bit D1, on or off states of a transmission gate included in a second unit circuit UC2 may be determined by a second bit D2, and on or off states of a transmission gate included in an N^{th} unit circuit UCN may be determined by an N^{th} bit DN.

The NMOS transmission switch TN included in the transmission gate of each of the plurality of unit circuits UC1 to UCN may be turned on/off by 1-bit data among N-bit data included in the resistance code, and the PMOS transmission switch TP may be turned on/off by complementary data of the 1-bit data. For example, when the first bit D1 is logic ‘1,’ a voltage corresponding to logic ‘1’ may be input to a gate of the NMOS transmission switch TN included in the first unit circuit UC1, and a voltage corresponding to logic ‘0’ may be input to a gate of the PMOS transmission switch TP included in the first unit circuit UC1. Therefore, both the NMOS transmission switch TN and the PMOS transmission switch TP, included in the first unit circuit UC1, may be turned on, such that a first unit resistor UR1 may not be reflected in the resistance value of the first resistive circuit R1. The resistance value of the first resistive circuit R1 may decrease, as the number of bits that is logical ‘1’ among the N bits D1 to DN constituting the resistance code increases, and the resistance value of the first resistive circuit R1 may increase, as the number of bits that is logical ‘0’ among the N bits D1 to DN constituting the resistance code increases.

The resistance values of each of the unit resistors UR1 to URN included in the plurality of unit circuits UC1 to UCN may be the same or different. For example, when the first resistive circuit R1 is configured such that each of the unit resistors UR1 to URN has the same resistance value, the resistance value of the first resistive circuit R1 may be linearly adjusted using a resistance code RCODE.

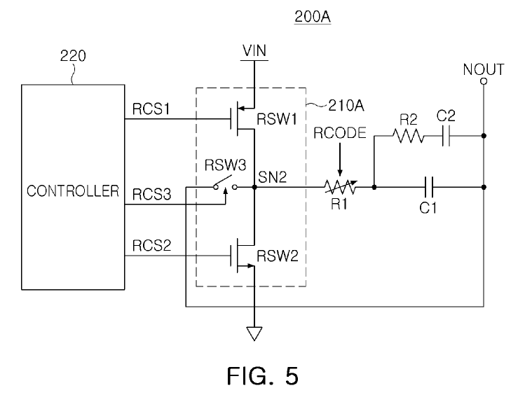

FIGS. 4 and 5 are views illustrating an electronic device including a ripple generator included in a power supply device according to one or more embodiments.

First, referring to FIG. 4, a ripple generator 200 may include a first resistive circuit R1, a first capacitor C1, a ripple resistor R2, a second capacitor C2, a switch circuit 210, and the like. In one or more embodiments illustrated in FIG. 4, the ripple generator 200 may further include the ripple resistor R2 and the second capacitor C2, connected in parallel with the first capacitor C1, and the ripple resistor R2 and the second capacitor C2 may be connected in series with each other. The first resistive circuit R1 may have a variable resistance characteristic in which a resistance value is determined according to a resistance code RCODE.

The switch circuit 210 may include first to third ripple switches RSW1 to RSW3. The first ripple switch RSW1 may be connected between an input node supplying an input voltage VIN and a second switching node SN2, and the second ripple switch RSW2 may be connected between a reference node supplying a reference voltage and the second switching node SN2. In one or more embodiments, the reference voltage may be a ground voltage.

The third ripple switch RSW3 may be connected between the second switching node SN2 and an output node NOUT. The output node NOUT may be an output node of a DC-DC converter included in a power supply device, together with the ripple generator 200.

The first to third ripple switches RSW1 to RSW3 may be controlled by ripple control signals RCS1 to RCS3 output by a controller 220. For example, the first ripple switch RSW1 may be turned on/off by a first ripple control signal RCS1, the second ripple switch RSW2 may be turned on/off by a second ripple control signal RCS2, and the third ripple switch RSW3 may be turned on/off by a third ripple control signal RCS3.

The controller 220 may turn on only one of the first to third ripple switches RSW1 to RSW3, and may turn off the remaining switches. For example, the first ripple switch RSW1 may be turned on, together with a first switch included in the DC-DC converter and connected to the input node, while the second ripple switch RSW2 and the third ripple switch RSW3 are off. In another example, the second ripple switch RSW2 may be turned on, together with a second switch included in the DC-DC converter and connected to the reference node, while the first ripple switch RSW1 and the third ripple switch RSW3 are off..

The third ripple switch RSW3 may be turned on during a period of time during which both the first ripple switch RSW1 and the second ripple switch RSW2 are turned off. As the third ripple switch RSW3 is turned on, the output node NOUT may be connected to the first resistive circuit R1, and an output voltage of the DC-DC converter may be input to the first resistive circuit R1. In this manner, the third ripple switch RSW3 may be turned on during a period of time during which both the first ripple switch RSW1 and the second ripple switch RSW2 are turned off and the output voltage of the DC-DC converter may be input to the first resistive circuit R1, the resistance value of the first resistive circuit R1 may be prevented from unintentionally changing, and a malfunction of the power supply device may be prevented. Hereinafter, this will be described in more detail with reference to FIG. 3.

For example, assuming that among N bits constituting a resistance code RCODE, a first bit D1 is logic ‘1’ and a second bit D2 is logic ‘0,’ a transmission gate may be turned on in a first unit circuit UC1, and a transmission gate may be turned off in a second unit circuit UC2. Therefore, a first unit resistor UR1 may not be reflected in a resistance value of a first resistive circuit R1, and a second unit resistor UR2 may be reflected in the resistance value of the first resistive circuit R1.

When all ripple switches RSW1 to RSW3 included in a switch circuit 210 are turned off under conditions in which the first bit D1 and the second bit D2 of the resistance code RCODE are determined, as described above, current may flow from a reference node to a second switching node SN2 through a diode existing between a source and a drain of a second ripple switch RSW2. Due to the current flowing from the reference node to the second switching node SN2, a voltage of the second switching node SN2 may decrease to a voltage, lower than a reference voltage, for example, a negative voltage.

When the voltage of the second switching node SN2 decreases to a negative voltage, a voltage of a node between the first unit circuit UC1 and the second unit circuit UC2 may also decrease to a negative voltage. Since the second bit D2 input to the second unit circuit UC2 is logic ‘0,’ a voltage corresponding to logic ‘0,’ for example, a reference voltage, may be input to a gate of an NMOS transmission switch TN of the second unit circuit UC2, and a voltage corresponding to logic ‘1,’ for example, an input voltage VIN may be input to a gate of a PMOS transmission switch TP.

In this state, as a voltage of a node between a first switching node SN1 and the second switching node SN2 decreases to a negative voltage, the NMOS transfer switch TN of the second unit circuit UC2 may be turned on. As the NMOS transfer switch TN is turned on, current may flow through the NMOS transfer switch TN, instead of the second unit resistor UR2, such that the second unit resistor UR2 may not be included in a resistance value of the first resistive circuit R1. Therefore, the resistance value of the first resistive circuit R1 may be set to be smaller than a resistance value intended by the resistance code RCODE.

When the resistance value of the first resistive circuit R1 changes unintentionally as described above, a phase difference between an inductor current flowing in an inductor of a DC-DC converter and an output voltage of the DC-DC converter may not be controlled as desired, and thus, an oscillation phenomenon may occur in the output voltage of the DC-DC converter. Therefore, operational stability of the power supply device may be degraded.

In one or more embodiments, the third ripple switch RSW3 may be turned on during a period of time during which both the first ripple switch RSW1 and the second ripple switch RSW2 are turned off. For example, the third ripple switch RSW3 may have a structure similar to a transmission gate included in each of the unit circuits UC1 to UCN of the first resistive circuit R1. The third ripple switch RSW3 may be turned on to connect the second switching node SN2 and the output node NOUT, the resistance value of the first resistive circuit R1 may be maintained at a resistance value corresponding to the resistance code RCODE, and operational stability of the power supply device may be improved.

Next, referring to FIG. 5, a ripple generator 200A according to one or more embodiments illustrated in FIG. 5 may have a structure similar to the ripple generator 200 described above with reference to FIG. 4. However, unlike the embodiment of FIG. 4 in which each of the first ripple switch RSW1 and the second ripple switch RSW2 are implemented with the NMOS transistor, in the embodiments illustrated in FIG. 5, a first ripple switch RSW1 may be implemented with a PMOS transistor, and a second ripple switch RSW2 may be implemented with an NMOS transistor. As understood by one of ordinary skill in the art, the embodiments are not limited to this configuration. For example, the first ripples switch RSW1 may be implemented with an NMOS transistor and the second ripple switch RSW2 may be implemented with a PMOS transistor.

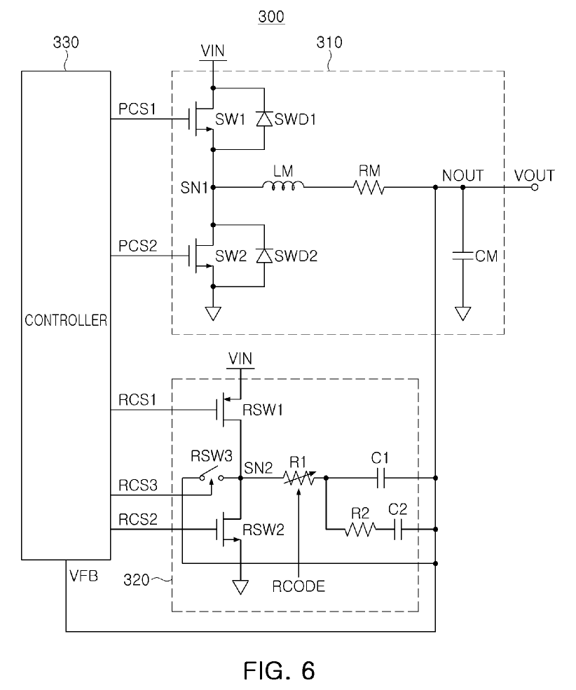

FIG. 6 is a circuit diagram illustrating a power supply device according to one or more embodiments.

Referring to FIG. 6, a power supply device 300 according to one or more embodiments may include a DC-DC converter 310, a ripple generator 320, a controller 330, and the like. The DC-DC converter 310 may convert an input voltage VIN into an output voltage VOUT in response to a power control signal (PCS1 and PCS2) output by the controller 330. The ripple generator 320 may be connected to an output node NOUT of the DC-DC converter 310, and may operate in response to a ripple control signal (RCS1 to RCS3) output by the controller 330.

The controller 330 may generate the power control signal (PCS1 and PCS2) and the ripple control signal (RCS1 to RCS3) by referring to a feedback voltage VFB detected from the output node NOUT. For example, the controller 330 may compare the feedback voltage VFB with a predetermined threshold voltage. When the feedback voltage VFB becomes smaller than the threshold voltage, the controller 330 may turn on a first switch SW1 with a first power control signal PCS1 to increase the output voltage VOUT. Conversely, when the feedback voltage VFB becomes higher than the threshold voltage, the controller 330 may turn on a second switch SW2 with a second power control signal PCS2 to decrease the output voltage VOUT.

The DC-DC converter 310 may include the first switch SW1, the second switch SW2, an inductor LM, a resistor RM, a capacitor CM, and the like. The first switch SW1 and the second switch SW2 may be connected in series between an input node supplying the input voltage VIN and a reference node supplying a reference voltage. The inductor LM may be connected to a first switching node SN1 between the first switch SW1 and the second switch SW2. The capacitor CM may be connected between the output node NOUT and the reference node.

The ripple generator 320 may include a first ripple switch RSW1, a second ripple switch RSW2, a third ripple switch RSW3, a first resistive circuit R1, a first capacitor C1, a ripple resistor R2, and a second capacitor C2. The first resistive circuit R1 may have a variable resistance characteristic having a resistance value determined by a resistance code RCODE, and for example, the resistance code RCODE may be generated by the controller 330.

The first resistive circuit R1 may be connected to a second switching node SN2 to which the first to third ripple switches RSW1 to RSW3 are connected to each other, and the first capacitor C1 may be connected between the first resistive circuit R1 and the output node NOUT. Referring to FIG. 6, the ripple resistor R2 and the second capacitor C2 may be connected in series with each other, and may be connected in parallel with the first capacitor C1. A connection structure of the first capacitor C1, the second capacitor C2, and the ripple resistor R2 may be changed depending on one or more embodiments.

The ripple generator 320 may be a circuit for intentionally adding ripple (e.g. a predetermined amount of ripple) to the output voltage VOUT of the DC-DC converter 310. For example, a switching frequency of the first switch SW1 and a switching frequency of the second switch SW2 included in the DC-DC converter 310 may be changed depending on a magnitude of the input voltage VIN, a magnitude of load connected to the output node NOUT, or the like. In one or more embodiments, under light load conditions in which the magnitude of the load connected to the output node NOUT is small, switching frequencies may decrease, and oscillation may occur due to a phase difference between current flowing in the inductor LM and the output voltage VOUT. Such oscillation may be prevented by intentionally adding a ripple component to the output voltage VOUT by the ripple generator 320.

In one or more examples, the second switching node SN2 of the ripple generator 320 may be directly connected to the first switching node SN1, and the ripple generator 320 may not include the ripple switches RSW1 to RSW3. Therefore, the first resistive circuit R1 may be directly connected to the first switch SW1 and the second switch SW2, and in this structure, a problem may occur in which current flows through a parasitic diode SWD2 of the second switch SW2 during a dead period of time during which both the first switch SW1 and the second switch SW2 are turned off.

When both the first switch SW1 and the second switch SW2 are turned on, a current path directly connecting the input node and the reference node may be generated, which may damage the first switch SW1 and/or the second switch SW2. To prevent this problem from occurring, a dead period of time during which both the first switch SW1 and the second switch SW2 are turned on may be intentionally set. Since the parasitic diode SWD2 present in the second switch SW2 during the dead period of time may be forwardly connected to an inductor current flowing from the first switching node SN1 to the output node NOUT, current may flow through the parasitic diode SWD2. Therefore, a voltage of the first switching node SN1 may decrease to a negative voltage.

When the first resistive circuit R1 is directly connected to the first switching node SN1, a resistance value may be changed as the voltage of the first switching node SN1 decreases to a negative voltage. As described above with reference to FIG. 3, the first resistive circuit R1 may include a plurality of unit circuits connected in series with each other, and each of the unit circuits may include a unit resistor and a transmission gate connected in parallel with the unit resistor. In one or more examples, the on and off states of the transmission gate included in each of the unit circuits may be controlled by the resistance code RCODE.

When the voltage of the first switching node SN1 to which the first resistive circuit R1 is directly connected decreases to a negative voltage, a transmission gate that should be turned off in at least one of the unit circuits may be turned on. Therefore, a resistance value of the first resistive circuit R1 may decrease to a resistance value, smaller than a resistance value intended by the resistance code RCODE, and operational stability of the power supply device 300 may be degraded.

In one or more embodiments, the problem may be prevented by connecting the first resistive circuit R1 to the second switching node SN2, separated from the first switching node SN1, and controlling the voltage of the second switching node SN2 with the ripple switches RSW1 to RSW3, different from the first switch SW1 and the second switch SW2. The controller 330 may control the first ripple switch RSW1 by synchronizing the same with the first switch SW1, and may control the second ripple switch RSW2 by synchronizing the same with the second switch SW2.

Therefore, a dead period of time during which both the first ripple switch RSW1 and the second ripple switch RSW2 are turned off may be present in the ripple generator 320. When a parasitic diode exists in the second ripple switch RSW2, current may flow from the reference node to the second switching node SN2 during the dead period of time, and the voltage of the second switching node SN2 may decrease to a negative voltage. Therefore, a resistance value of the first resistive circuit R1 may decrease to a resistance value, smaller than a resistance value intended by the resistance code RCODE.

In one or more embodiments, during a dead period of time during which both the first ripple switch RSW1 and the second ripple switch RSW2 are turned off, the third ripple switch RSW3 may be turned on. For example, the third ripple switch RSW3 may be turned on during at least a portion of the dead period of time. As the third ripple switch RSW3 is turned on, the second switching node SN2 may be connected to the output node NOUT during the dead period of time. The third ripple switch RSW3 may be turned on to maintain a voltage of the second switching node SN2 as the output voltage VOUT, the resistance value of the first resistive circuit R1 may be maintained at the resistance value intended by the resistance code RCODE, and operational stability of the power supply device 300 may be improved.

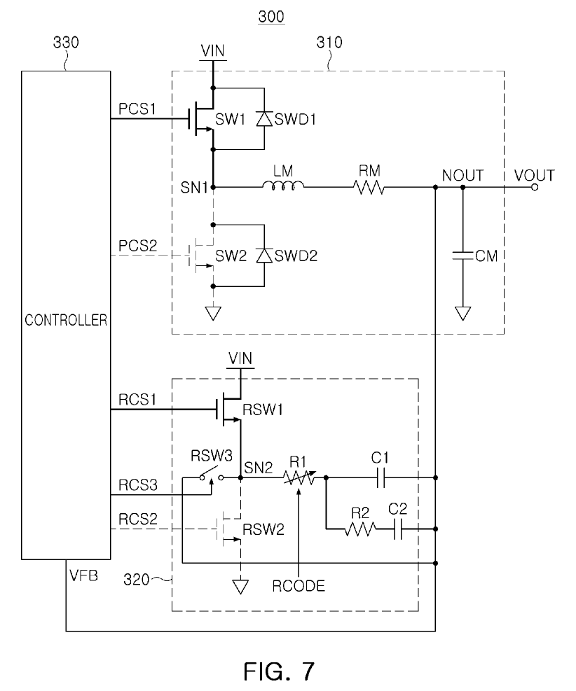

FIGS. 7 to 12 are views illustrating an operation of a power supply device according to one or more embodiments. In FIGS. 7 to 12, in one or more examples, a switch being turned on may be represented by solid lines, and a switch being turned may be represented by dotted lines.

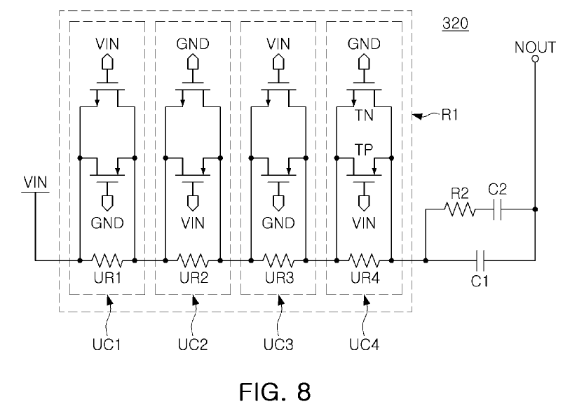

FIGS. 7 and 8 may be views illustrating an operation of a power supply device 300 during a period of time during which a first switch SW1 is turned on. As the first switch SW1 is turned on and a second switch SW2 is turned off, an input voltage VIN may be supplied to a first switching node SN1 in a DC-DC converter 310. Therefore, an output voltage VOUT may increase due to an inductor current flowing in an inductor LM.

In a ripple generator 320, a first ripple switch RSW1 may be turned on and a second ripple switch RSW2 and a third ripple switch RSW3 may be turned off. Therefore, an input voltage VIN may be supplied to a second switching node SN2.

In the embodiments described with reference to FIGS. 7 to 12, a first resistive circuit R1 may include first to fourth unit circuits UC1 to UC4, and the first to fourth unit circuits UC1 to UC4 may be connected in series with each other. The first resistive circuit R1 may have a resistance value set by a resistance code RCODE, and the resistance code RCODE may include 4-bit data determining a on or off state of a transmission gate included in each of the first to fourth unit circuits UC1 to UC4.

In the embodiments described with reference to FIGS. 7 to 12, the resistance code RCODE may include data of [1010]. For example, the on or off states of the transmission gate included in the first unit circuit UC1 may be determined by a first bit of the data included in the resistance code RCODE. Referring to FIG. 8, by the resistance code RCODE, the transmission gates may be turned on in each of the first unit circuit UC1 and the third unit circuit UC3, and may be turned off in each of the second unit circuit UC2 and the fourth unit circuit UC4. Therefore, the resistance value of the first resistive circuit R1 may be determined by a sum of a second unit resistor UR2 and a fourth unit resistor UR4.

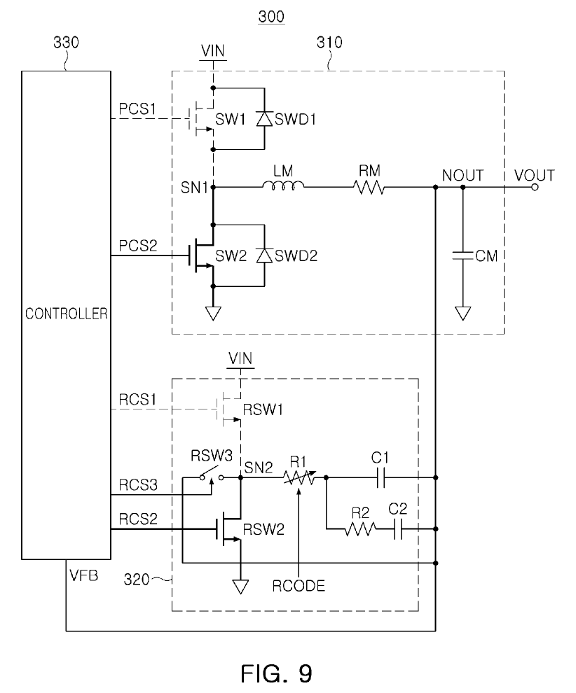

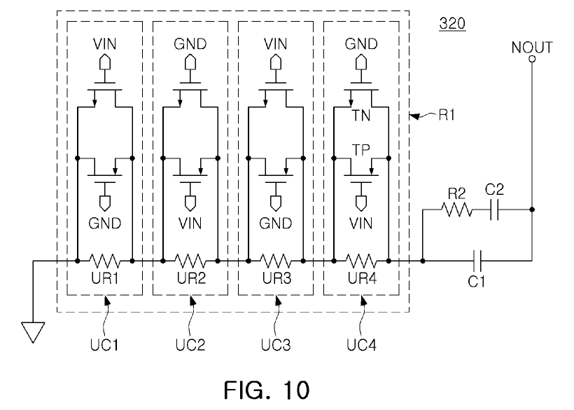

FIG. 9 and FIG. 10 may be views illustrating an operation of the power supply device 300 during a period of time during which the second switch SW2 and the second ripple switch RSW2 are turned on. As the second switch SW2 and the second ripple switch RSW2 are turned on, each of the first switching node SN1 and the second switching node SN2 may be connected to a reference node. Therefore, the output voltage VOUT may decrease.

Referring to FIG. 10, during the period of time during which the second switch SW2 and the second ripple switch RSW2 are turned on, the resistance value of the first resistive circuit R1 may be maintained as it is. For example, when the second switching node SN2 is connected to the reference node, an NMOS transmission switch TN in the transmission gate of the first unit circuit UC1 may be turned on, and both the NMOS transmission switch TN and a PMOS transmission switch TP in the transmission gate of the second unit circuit UC2 may be turned off.

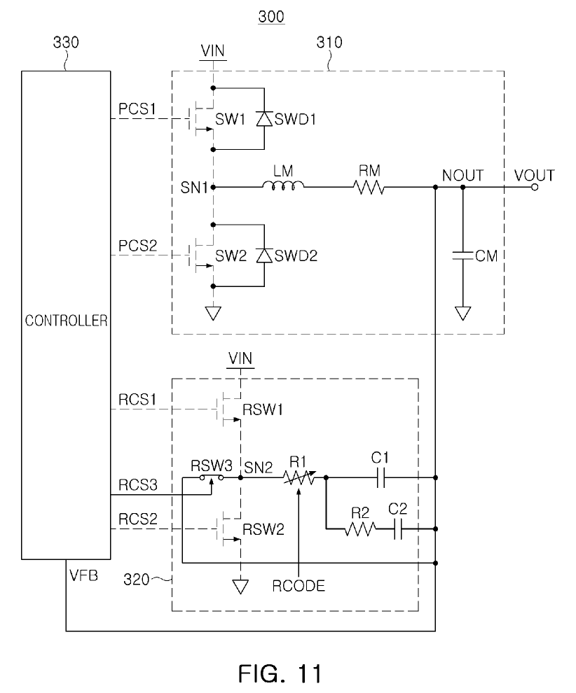

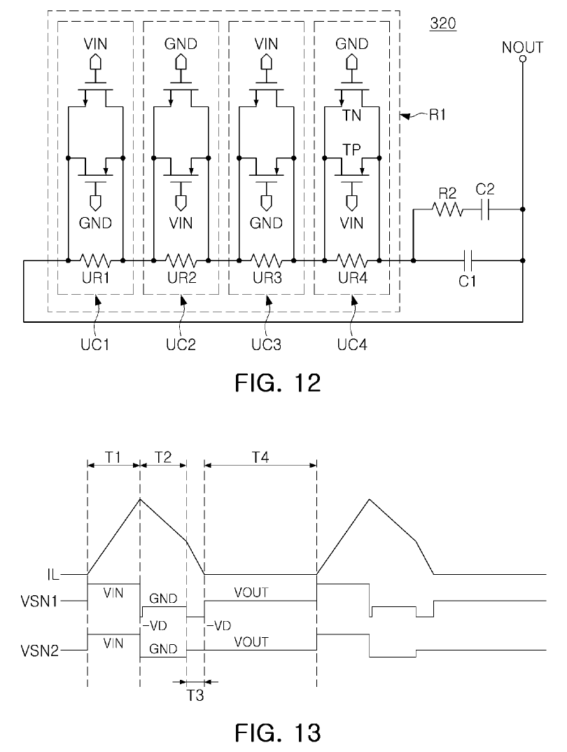

FIG. 11 and FIG. 12 may be views illustrating an operation of the power supply device 300 during a dead period of time during which both the first switch SW1 and the second switch SW2 are turned off. As described above, when both the first switch SW1 and the second switch SW2 are turned on, an input node and the reference node may be directly connected, which may cause the first switch SW1 and/or the second switch SW2 to be damaged. To prevent this, the dead period of time during which both the first switch SW1 and the second switch SW2 are turned off may be intentionally set between a turn-on period of time of the first switch SW1 and a turn-on period of time of the second switch SW2.

Since a controller 330 controls the first ripple switch RSW1 and the second ripple switch RSW2 in synchronization with the first switch SW1 and the second switch SW2, the first ripple switch RSW1 and the second ripple switch RSW2 may also be turned off during the dead period of time. A parasitic diode existing between a source and a drain of the second ripple switch RSW2 may be turned on during the dead period of time, which may cause a voltage of the second switching node SN2 to decrease.

As the voltage of the second switching node SN2 decreases, a problem in which the transmission gate is unintentionally turned on in some of the unit circuits UC1 to UC4 may occur, as described above with reference to FIG. 3. For example, assuming that the resistance code RCODE is [1010], the NMOS transmission switch TN included in the second unit circuit UC2 may be turned on due to a decrease in voltage of the second switching node SN2. Therefore, the resistance value of the first resistive circuit R1 may decrease from the sum of the second unit resistor UR2 and the fourth unit resistor UR4 to a resistance value of the fourth unit resistor UR4, and operational stability of the power supply device 300 may be deteriorated.

In one or more embodiments, as illustrated in FIGS. 11 and 12, the third ripple switch RSW3 may be turned on during the dead period of time during which the first ripple switch RSW1 and the second ripple switch RSW2 are turned off. Therefore, even though the second switching node SN2 is connected to the output node NOUT through the third ripple switch RSW3 and the parasitic diode of the second ripple switch RSW2 is turned on, the decrease in voltage of the second switching node SN2 may be prevented. The first resistive circuit R1 may maintain the resistance value intended by the resistor code RCODE even during the dead period of time, and the output voltage VOUT of the power supply device 300 may be stably maintained.

FIG. 13 is a waveform diagram illustrating an operation of a power supply device according to one or more embodiments.

Hereinafter, for the convenience of explanation, an operation of a power supply device 300 will be explained with reference to FIG. 6 together. Referring to FIGS. 6 and 13 together, an operation of a DC-DC converter 310 may be divided into a first period of time T1 during which a first switch SW1 is turned on, a second period of time T2 during which a second switch SW2 is turned on, a third period of time T3 and a fourth period of time T4 which may be dead period of times during which both the first switch SW1 and the second switch SW2 are turned off.

During the first period of time T1, the first switch SW1 may be turned on, and an input node may be connected to a first switching node SN1. Therefore, an inductor current IL flowing in an inductor LM of the DC-DC converter 310 may increase. Since the first switch SW1 and a first ripple switch RSW1 operate in synchronization, the first ripple switch RSW1 may be turned on during the first period of time T1 such that a second switching node SN2 may also be connected to the input node. Therefore, as illustrated in FIG. 13, a voltage VSN1 of the first switching node SN1 and a voltage VSN2 of the second switching node SN2 may be set to an input voltage VIN during the first period of time T1.

A short dead period of time may be set between the first period of time T1 and the second period of time T2. The dead period of time may be set for the purpose of preventing a large amount of current from flowing through the first switch SW1 and the second switch SW2 due to switching timing of the first switch SW1 and the second switch SW2 not being properly controlled. During the dead period of time, a parasitic diode SWD2 present in the second switch SW2 may be turned on, thereby decreasing the voltage VSN1 of the first switching node SN1 to a diode reverse voltage -VD.

When the second switch SW2 is turned on, a reference node may be connected to the first switching node SN1, and the inductor current IL may decrease. When the second period of time T2 elapses, the second switch SW2 may be turned off, and the inductor current IL may continue to decrease. During the third period of time T3 during which the second switch SW2 is turned off, the parasitic diode SWD2 of the second switch SW2 may be turned on, thereby decreasing the voltage VSN1 of the first switching node SN1 to the diode reverse voltage -VD.

Since the first ripple switch RSW1 and a second ripple switch RSW2 operate in synchronization with the first switch SW1 and the second switch SW2, respectively, a phenomenon in which the voltage VSN1 of the first switching node SN1 decreases to the diode reverse voltage -VD during the dead period of time may also occur at the second switching node SN2. For example, as both the first ripple switch RSW1 and the second ripple switch RSW2 are turned off during the dead period of time and current flows to the parasitic diode of the second ripple switch RSW2, the voltage VSN2 of the second switching node SN2 may decrease to the diode reverse voltage -VD.

In one or more embodiments, the problem may be prevented by turning on a third ripple switch RSW3 in a ripple generator 320 during the dead period of time. Referring to FIG. 13, during the third period of time T3, which may be a dead period of time during which both the first switch SW1 and the second switch SW2 are turned off, the third ripple switch RSW3 may be turned on. For example, when the second switch SW2 is switched from a turn-on state to a turn-off state, the third ripple switch RSW3 may be turned on, which can also be understood as the third ripple switch RSW3 being turned on, at least, during a portion of a period of time during which the inductor current IL decreases. Therefore, the voltage VSN2 of the second switching node SN2 may be maintained at the output voltage VOUT during the third period of time T3.

The fourth period of time T4 may be an idle period of time of the DC-DC converter 310. During the fourth period of time T4, the first switch SW1 and the second switch SW2, the first ripple switch RSW1, and the second ripple switch RSW2 may be all turned off, and the third ripple switch RSW3 may be maintained in a turned-on state. For example, the fourth period of time T4 may be set to be equal to or greater than a minimum idle period of time, and when a feedback voltage VFB detected from an output node NOUT decreases to a predetermined threshold voltage or lower, operations of the first period of time to the third period of time T1 to T3 may be started again.

In this manner, in one or more embodiments, the switches SW1 and SW2 of the DC-DC converter 310 and the ripple switches RSW1 to RSW3 of the ripple generator 320 may be implemented as separate elements to separate the first switching node SN1 and the second switching node SN2. Therefore, a decrease in voltage of the second switching node SN2 may be minimized regardless of a decrease in voltage of the first switching node SN1 during a dead period of time during which all the switches SW1 and SW2 of the DC-DC converter 310 are turned off. In addition, by turning on the third ripple switch RSW3 may be turned on during the dead period of time to connect the second switching node SN2 and the output node NOUT, a resistance value of the first resistive circuit R1 may be maintained at an intended value as the resistance code RCODE even during the dead period of time, and operational stability of the power supply device 300 may be improved.

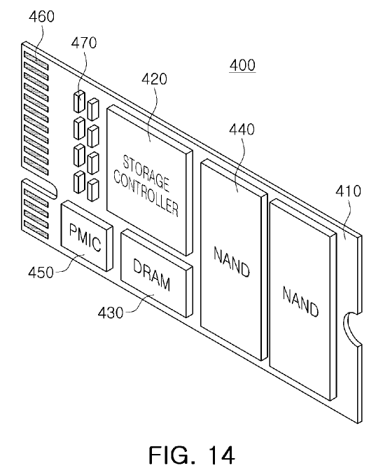

FIG. 14 is a view illustrating a system including a power supply device according to one or more embodiments.

Referring to FIG. 14, a system to which a power supply device according to one or more embodiments is applied may be a storage system 400. The system to which a power supply device according to one or more embodiments is applied is not necessarily limited to the storage system 400, and a power supply device according to one or more embodiments may be applied to any system that requires conversion of a DC voltage.

A storage system 400 according to one or more embodiments, as illustrated in FIG. 14, may be a solid state drive system. Referring to FIG. 14, the storage system 400 may have a form factor according to an M.2 standard, and may communicate with an external host device, such as a central processing unit, a system-on-chip, an application processor, or the like according to a PCI-Express protocol.

The storage system 400 may include a system board 410, a storage controller 420, a RAM device 430, memory devices 440, a power supply device 450, and the like. The storage controller 420, the RAM device 430, the memory devices 440, the power supply device 450, and the like may be electrically connected to each other by wiring patterns formed on the system board 410.

The system board 410 may include a connector 460 including a plurality of pins for connection with a host device. The number and arrangement of the plurality of pins included in the connector 460 may be changed depending on an interface defining a connection method between the storage system 400 and the host device. In example embodiments, the storage system 400 may communicate with an external host according to any one of interfaces such as a universal serial bus (USB), a peripheral component interconnect express (PCI-Express), a serial advanced technology attachment (SATA), an M-Phy for universal flash storage (UFS), or the like. For example, a storage system 400 according to one or more embodiments, as illustrated in FIG. 14, may communicate with the host device according to the PCI-Express protocol.

The storage system 400 may operate by power supplied from the host device through the connector 460. The power supply device 450 may be a power management integrated circuit (PMIC) generating internal voltages necessary for operation of the storage controller 420, the RAM device 430, the memory devices 440, or the like, by using an external voltage supplied from the host device through the connector 460.

The power supply unit 450 may use the external voltage received through the connector 460 as an input voltage, and may output an output voltage increasing or decreasing the external voltage as the internal voltage. The power supply unit 450 may be implemented according to at least one of the embodiments described above with reference to FIGS. 1 to 13, and may include a DC-DC converter and a ripple generator.

For example, switches of the DC-DC converter and ripple switches of the ripple generator may be controlled by the storage controller 420. The storage controller 420 may detect an output voltage of the DC-DC converter as a feedback voltage, and may compare the feedback voltage with a predetermined threshold voltage to control the switches of the DC-DC converter. The storage controller 420 may control some of the ripple switches by synchronizing them with the switches of the DC-DC converter, and may turn on at least one of the ripple switches during a dead period of time during which all the switches of the DC-DC converter are turned off. A ripple switch that may be turned on during the dead period of time may be connected to an output node of the DC-DC converter.

The ripple generator may include a resistive circuit that may change a resistance value. The resistance value of the resistive circuit may be determined by a resistance code generated by the storage controller 420. For example, the resistive circuit may include N unit circuits, and the storage controller 420 may generate a resistance code including N bits of data. On or off states of a transmission gate included in each of the N unit circuits may be determined by each bit included in the N bits of data.

In one or more embodiments, the switches of the DC-DC converter and the ripple switches of the ripple generator may be implemented as separate elements, to prevent a situation in which the resistance value of the resistive circuit changes unintentionally during the dead period of time. In addition, at least one of the ripple switches may be turned on during the dead period of time, and may be connected directly to the output node of the DC-DC converter, operational stability of the power supply device 450 may be further improved.

The storage controller 420 may write data to the memory devices 440 or may read data from the memory devices 440 in response to a command received from the host device. For example, the storage system 400 may include a plurality of memory devices 440 mounted on the system board 410, and each of the plurality of memory devices 440 may include two or more memory chips. The memory chips may have a non-volatile characteristic in which stored data is maintained even when power is cut off, and may be NAND memory chips.

A storage system 400 according to one or more embodiments, as illustrated in FIG. 14, may include the RAM device 430 operating as a buffer memory for alleviating a difference in speed between the memory devices 440 in which data is stored, and the host device. For example, the RAM device 430 may be a dynamic random access memory (DRAM), and may act as a kind of cache memory to provide a space for temporarily storing data in a control operation for the memory devices 440.

According to one or more embodiments, a ripple generator connected to a DC-DC converter may include ripple switches implemented as separate elements from switches of the DC-DC converter, and at least one of the ripple switches may be turned on during a period of time during which the switches of the DC-DC converter are turned off, thereby connecting the ripple generator to an output node of the DC-DC converter. Therefore, a resistance value of a resistive circuit included in the ripple generator may be accurately controlled to a target resistance value, and a malfunction of a power supply device may be effectively prevented.

Various advantages and effects of the present disclosure are not limited to the above-described contents, and will be more easily understood in the process of explaining specific embodiments.

While example embodiments have been illustrated and described above, it will be apparent to those skilled in the art that modifications and variations could be made without departing from the scope of the present disclosure as defined by the appended claims.

What is claimed is:

1. A power supply device comprising:
a DC-DC converter; and
a ripple generator,
wherein the DC-DC converter comprises:
a first switch connected between an input node supplying an input voltage and a first switching node, and
a second switch connected between a reference node supplying a reference voltage, different from the input voltage, and the first switching node,
wherein the DC-DC converter is configured to output an output voltage, which is different from the input voltage, by switching operation of each of the first switch and the second switch, to an output node, and
wherein the ripple generator comprises:
a first capacitor connected to the output node,
a first resistive circuit connected between the first capacitor and a second switching node,
a first ripple switch connected between the second switching node and the input node,
a second ripple switch connected between the second switching node and the reference node, and
a third ripple switch connected between the second switching node and the output node.

2. The power supply device of claim 1, wherein the first resistive circuit comprises a plurality of unit circuits connected in series between the second switching node and the first capacitor, and
wherein each of the plurality of unit circuits comprises at least one transmission gate and at least one unit resistor connected in parallel with the at least one transmission gate.

3. The power supply device of claim 2, wherein the plurality of unit circuits further comprise a first unit circuit and a second unit circuit, and
wherein a resistance value of a first unit resistor included in the first unit circuit is different from a resistance value of a second unit resistor included in the second unit circuit.

4. The power supply device of claim 1, wherein the DC-DC converter further comprises:
an inductor connected to the first switching node,
a capacitor between the output node and the reference node, and
a resistor connected between the inductor and the output node.

5. The power supply device of claim 1, wherein the ripple generator further comprises a ripple resistor and a second capacitor, connected in parallel with the first capacitor, and
wherein the ripple resistor and the second capacitor are connected in series with each other.

6. The power supply device of claim 1, wherein the first switch is an N-type metal-oxide-semiconductor (NMOS) transistor, and the second switch is an NMOS transistor.

7. The power supply device of claim 1, wherein a gate of the first switch and a gate of the first ripple switch are connected,
wherein a gate of the second switch and a gate of the second ripple switch are connected, and
wherein a gate of the third ripple switch is separated from the gate of the first switch, the gate of the second switch, the gate of the first ripple switch, and the gate of the second ripple switch.

8. The power supply device of claim 1, wherein the first switching node and the second switching node are separated.

9. A power supply device comprising:
a DC-DC converter configured to receive an input voltage and output an output voltage, the DC-DC converter comprising a first switch and a second switch;
a ripple generator connected to an output node of the DC-DC converter, the ripple generator comprising a first ripple switch, a second ripple switch, and a third ripple switch; and
a controller configured to control the first switch, the first ripple switch, the second switch, the second ripple switch, and the third ripple switch,
wherein the ripple generator comprises a first resistive circuit connected to a switching node to which the first ripple switch,
wherein the second ripple switch and the third ripple switch are connected to each other, and a first capacitor connected between the first resistive circuit and the output node,
wherein the third ripple switch is connected between the switching node and the output node, and
wherein the controller turns the third ripple switch on during at least a portion of a dead period of time during which the first switch, the first ripple switch, the second switch, and the second ripple switch are turned off.

10. The power supply device of claim 9, wherein the DC-DC converter further comprises an inductor connected between the output node and a node between the first switch and the second switch.

11. The power supply device of claim 10, wherein the controller is configured to:
turn the first switch and the first ripple switch on with a first control signal for a first period of time to increase an inductor current flowing in the inductor, and
turn the first switch and the second ripple switch on with a second control signal for a second period of time, different from the first period of time, to decrease the inductor current.

12. The power supply device of claim 11, wherein, for a third period of time after the second period of time, the controller is further configured to turn the first switch, the first ripple switch, the second switch, and the second ripple switch off, and turn the third ripple switch on.

13. The power supply device of claim 11, wherein the dead period of time is included in a period of time during which the inductor current decreases.

14. The power supply device of claim 9, wherein the first resistive circuit further comprises a plurality of unit circuits connected in series between the switching node and the first capacitor, and
wherein each of the plurality of unit circuits comprises a unit resistor and a transmission gate connected in parallel with the unit resistor.

15. The power supply device of claim 14, wherein the controller is configured to generate a resistance code turning on or turning off the transmission gate included in each of the plurality of unit circuits.

16. The power supply device of claim 15, wherein the resistance code comprises data of N bits,
wherein N is a natural number equal to or greater than 2, and
wherein a number of the plurality of unit circuits is N.

17. A power supply device comprising:
a DC-DC converter; and
a ripple generator,
wherein the DC-DC converter comprises:
at least one inductor,
a first switch, and
a second switch,
wherein the at least one inductor, the first switch, and the second switch are connected to each other at a first switching node, and
wherein the ripple generator comprises
at least one ripple switch connected between an output node of the DC-DC converter and a second switching node,
a first resistive circuit, and
a first capacitor, connected in series, between the output node and the second switching node.

18. The power supply device of claim 17, wherein the at least one ripple switch is turned on at least a portion of a period of time during which an inductor current flowing through the at least one inductor decreases.

19. The power supply device of claim 18, wherein the at least one ripple switch is turned on when the second switch is switched from a turn-on state to a turn-off state.

20. The power supply device of claim 17, wherein each of the first switch and the second switch is implemented with a single transistor, and the at least one ripple switch is implemented with a transmission gate.
